(19) United States
(12) Patent Application Publication
(10) Pub. No.: US 2007/0268802 A1
(43) Pub. Date: Nov. 22, 2007

(54) Optical disc recording and reproducing apparatus

(75) Inventor: Keiichi Muramatsu, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/798,586

(22) Filed: May 15, 2007

(30) Foreign Application Priority Data
May 19, 2006 (JP) 2006-139685

(51) Int. Cl. G11B 7/00; G11B 27/36

(52) U.S. Cl. 369/53.35; 369/53.2

(57) ABSTRACT

An optical disc recording and reproducing apparatus includes: an error occurrence deciding unit that decides whether or not a record error occurred during recording operation on an optical disc; an error information storing unit that stores record error information in a memory when the record error occurred; and an error information recording unit that reads out the record error information from the memory and records the record error information in a predetermined area on the optical disc when the recording operation is finished if a record error occurred during the recording operation.

This application is based on Japanese Patent Application No. 2006-139685 filed on May 19, 2006, the contents of which are hereby incorporated by reference.

### BACKGROUND OF THE INVENTION

1. Field of the Invention

The present invention relates to an optical disc recording and reproducing apparatus, in particular an optical disc recording and reproducing apparatus having a function of recording record error information on an optical disc.

2. Description of Related Art

Recently, a digital versatile disc (DVD) that is an optical disc capable of recording a large quantity of information such as picture and audio data of a movie or the like is widely available. There are known several types of DVDs including a DVD-ROM on which information is recorded on a manufacture's side and cannot be rewritten on a user's side, a DVD−R or a DVD+R on which information can be written only once on a user's side, and a DVD−RW or a DVD+RW or the like on which information can be rewritten a predetermined number of times on a user's side. Information recorded on these DVDs can be reproduced by using an optical disc reproducing apparatus (i.e., a DVD player) or an optical disc recording and reproducing apparatus (i.e., a DVD recorder), and information can be recorded on a DVD−R, a DVD+R, a DVD−RW, a DVD+RW or the like by using the optical disc recording and reproducing apparatus.

In addition, when the conventional optical disc recording and reproducing apparatus reproduces data recorded on an optical disc, it converts an RF signal that is a read signal from an optical pickup into digital data. After that, it performs a signal demodulation process in accordance with a data format of the optical disc and an error correction process using an error correction code (ECC) block. This error correction function of performing the error correction process enables to recover data loss to a certain extent. Further, in the case of picture and audio data, even if data loss cannot be recovered by the error correction function completely, data correction thereof can be performed by data interpolation to a level of defect that a user cannot recognize.

In the case of analog data recorded on a magnetic tape such as a video cassette tape, a user can recognize wear and tear of the magnetic tape from its reproduced picture. However, in the case of digital data recorded on an optical disc such as a DVD, a user cannot sense directly deterioration in the data due to a scratch on the recording surface or a dye change, because of the error correction process. In this case, the data may become unreadable abruptly as the deterioration proceeds. If this phenomenon happens, the user may need to inquire a service center of a manufacturer of the disc about the cause of the phenomenon because the user cannot detect what causes the phenomenon.

It is considered that this cause may be a record error that occurs when the data is recorded. However, in order to make the cause clear, record error information is necessary that includes an error occurrence address when the record error occurred upon recording, a recording power of a laser beam emitted from the optical pickup just before the record error occurred, an error code that indicates contents of the record error, an internal error code that indicates contents of the error more specifically than the error code and error occurrence time indicating time when the record error occurred.

However, in the case where the optical disc is a DVD−R, a DVD−RW, a DVD+R, or a DVD+RW, the conventional optical disc recording and reproducing apparatus does not have a function of recording the record error information including the error occurrence address, the recording power, the error code, the internal error code and the error occurrence time on the optical disc. Therefore, even if the user sends the optical disc that causes a problem to a service center or the like of the manufacturer of the optical disc, they cannot make the cause of the problem clear and cannot deal with the user's complaint. In addition, they cannot use the user's complaint for developing an improved disc in the future, which may cause lowered efficiency in developing discs.

There are following conventional techniques for dealing with defects in recording process on an optical disc or the like. JP-A-2003-263737 discloses a technique in which each data area on the optical disc records a flag indicating whether or not an exchange process was performed with respect to the data area, and an exchange flag table of the flag is generated in an unused area of a lead-in area on the optical disc. Since a data area that does not includes the exchange process due to a defect does not need searching of a defect management table, process time necessary for recording or reproducing in the data area can be shortened. However, this conventional technique deals with a CD−R or a CD−RW as the optical disc. It does not deal with a DVD−R, a DVD−RW, a DVD+R or a DVD+RW, so it cannot counter a problem if it occurs to one of these optical discs.

JP-A-2001-357625 discloses a technique that uses linking type information that indicates linking generated in the next to a defect area other than linking generated upon continuous increase record or limited overwrite record, so as to increase reliability of user data even if a large defect occurs on the recording medium so that a reference signal necessary for recording or reproducing is not generated, by restarting record of the user data after applying the linking system is applied to the next area of the defect area. However, this conventional technique does not have a function of recording the record error information such as the error occurrence address, the recording power, the error code, the internal error code and the error occurrence time on a DVD−R, a DVD−RW, a DVD+R or a DVD+RW. Therefore, even if the user sends the optical disc that causes a problem to a service center or the like of the manufacturer of the optical disc, they cannot make the cause of the problem clear and cannot deal with the user's complaint. In addition, they cannot use the user's complaint for developing an improved disc in the future, which may cause lowered efficiency in developing discs.

JP-A-2000-113453 discloses a technique that records information necessary for reproducing user data in an unused area that is a track or a set of tracks adjacent to a zone boundary on the optical disc and is not used for recording user data, so that decrease of format efficiency can be avoided effectively. However, this technique does not record the record error information such as the error occurrence address, the recording power, the error code, the internal error code and the error occurrence time on a DVD−R, a DVD−RW, a DVD+R or a DVD+RW.

### SUMMARY OF THE INVENTION

In view of the above described problems, it is an object of the present invention to provide an optical disc recording and reproducing apparatus that can record the record error information in an unused area on the optical disc if a record error occurs while recording information on the optical disc such as a DVD−R, a DVD−RW, a DVD+R, a DVD+RW or the like.

To attain the above described object, an optical disc recording and reproducing apparatus in accordance with a first aspect of the present invention includes: an error occurrence deciding unit that decides whether or not a record error occurred during recording operation on an optical disc; an error information storing unit that stores record error information in a memory when the record error occurred; and an error information recording unit that reads out the record error information from the memory and records the record error information in a predetermined area on the optical disc when the recording operation is finished if a record error occurred during the recording operation.

In this structure, if a record error occurred during the recording operation is performed on the optical disc, record error information is stored in the memory. When the recording operation on the optical disc is finished, record error information is read out from the memory and is recorded in a predetermined area on the optical disc.

According to this structure, with respect to the optical disc on which a record error occurred during recording operation, record error information such as an error occurrence address, a recording power, an error code, an internal error code and an error occurrence time are recorded on it after the recording operation is finished. Therefore, if this optical disc causes a problem when it is reproduced, and it cannot be read, the user can send this optical disc to a service center or the like of the manufacturer of the optical disc so that the manufacturer of the optical disc can analyze the record error information recorded on the optical disc for finding out a cause of the error clear. Thus, the manufacturer of the optical disc can deal with the user's complaint and can use the information for developing an improved disc in the future and for improving efficiency in developing discs.

An optical disc recording and reproducing apparatus in accordance with a second aspect of the present invention is characterized by a structure in that the predetermined area in which the record error information is recorded on the optical disc is a recording management area in the case where the optical disc is a DVD−R or a DVD−RW, while it is an initial zone in the case where the optical disc is a DVD+R or a DVD+RW.

An optical disc recording and reproducing apparatus in accordance with a third aspect of the present invention further includes a disc discriminating unit that discriminates a type of the optical disc based on disc information; and an error occurrence confirming unit that confirms whether or not a record error occurred during the recording operation by detecting whether or not the record error information is stored in the memory when the recording operation on the optical disc is finished. And the optical disc recording and reproducing apparatus is characterized by a structure in that the predetermined area is decided in accordance with a result of the discrimination performed by the disc discriminating unit.

Therefore, the optical disc recording and reproducing apparatus can realize a disc discriminating process, an error occurrence deciding process, an error information storing process, an error occurrence confirming process and an error information recording process. Thus, if a record error occurred during the recording operation, record error information can be stored in the memory and the record error information can be recorded on the optical disc after the recording operation.

An optical disc recording and reproducing apparatus in accordance with a fourth aspect of the present invention is characterized by a structure in that the predetermined area is a recording management area in the case where the optical disc is a DVD−R or a DVD−RW, while it is an initial zone in the case where the optical disc is a DVD+R or a DVD+RW.

To attain the above described object, an optical disc recording and reproducing apparatus in accordance with a fifth aspect of the present invention includes: a disc discriminating unit that discriminates a type of an optical disc based on disc information; an error occurrence deciding unit that decides whether or not a record error occurred during recording operation on the discriminated optical disc based on an error correction result; an error information storing unit that stores record error information in a memory when the record error occurred; an error occurrence confirming unit that confirms whether or not a record error has occurred during the recording operation on the optical disc by detecting whether or not the record error information is stored in the memory when the recording operation on the optical disc is finished; and an error information recording unit that reads out the record error information from the memory, if it is confirmed that the record error occurred, and records the record error information in a recording management area in the case where the optical disc is a DVD−R or a DVD−RW, while records the same in an initial zone in the case where the optical disc is a DVD+R or a DVD+RW.

In this structure, when the optical disc is loaded first, the disc discriminating portion discriminates whether the optical disc is a DVD−R/DVD−RW or a DVD+R/DVD+RW based on disc information thereof. Then, the recording operation is performed on the disc-discriminated optical disc, and the error occurrence deciding unit decides whether or not a record error occurs during the recording operation. If a record error occurs, and the error occurrence deciding unit decides that a record error occurred, record error information such as an error occurrence address, a recording power, an error code, an internal error code and an error occurrence time indicating time when the record error occurred is stored by the error information storing unit in the memory. When the recording operation is finished, the error occurrence confirming unit detects whether or not error information is stored in the memory so as to confirm whether or not a record error has occurred during the recording operation on the optical disc. If the memory stores error information so it is confirmed that a record error has occurred during the recording operation, record error information is recorded by the error information recording unit in a predetermined area on the optical disc. More specifically, if the disc-discriminated optical disc is a DVD−R or a DVD−RW, the record error information is recorded in a recording management area (RMA) on the DVD−R or the DVD−RW. If the disc-discriminated optical disc is a DVD+R or a DVD+RW, the record error information is recorded in an initial zone on the DVD+R or the DVD+RW.

According to this structure, with respect to the optical disc (a DVD−R, a DVD−RW, a DVD+R or a DVD+RW) on which a record error occurred during recording operation, record error information such as an error occurrence address, a recording power, an error code, an internal error code and an error occurrence time are recorded on it after the recording operation is finished. Therefore, if this optical disc causes a problem when it is reproduced, and it cannot be read, the user can send this optical disc to a service center or the like of the manufacturer of the optical disc so that the manufacturer of the optical disc can analyze the record error information recorded on the optical disc for finding out a cause of the error clear. Thus, the manufacturer of the optical disc can deal with the user's complaint and can use the information for developing an improved disc in the future and for improving efficiency in developing discs.

As described above, an optical disc recording and reproducing apparatus in accordance with a fifth aspect of the present invention that has a system controller includes: a disc discriminating unit that discriminates a type of an optical disc based on disc information; an error occurrence deciding unit that decides whether or not a record error occurred during recording operation on the discriminated optical disc based on an error correction result; an error information storing unit that stores record error information in a memory when the record error occurred; an error occurrence confirming unit that confirms whether or not a record error has occurred during the recording operation on the optical disc by detecting whether or not the record error information is stored in the memory when the recording operation on the optical disc is finished; and an error information recording unit that reads out the record error information from the memory, if it is confirmed that the record error occurred, and records the record error information in a recording management area in the case where the optical disc is a DVD−R or a DVD−RW, while records the same in an initial zone in the case where the optical disc is a DVD+R or a DVD+RW. Therefore, with respect to the optical disc (a DVD−R, a DVD−RW, a DVD+R or a DVD+RW) on which a record error occurred during recording operation, it is able to record on it the record error information such as an error occurrence address, a recording power, an error code, an internal error code and an error occurrence time after the recording operation is finished.

Therefore, if the optical disc causes a problem when it is reproduced, and it cannot be read, the user can send this optical disc to a service center or the like of the manufacturer of the optical disc so that the manufacturer of the optical disc can analyze the record error information recorded on the optical disc for finding out a cause of the error clear. Thus, the manufacturer of the optical disc can deal with the user's complaint and can use the information for developing an improved disc in the future and for improving efficiency in developing discs.

Further, an optical disc recording and reproducing apparatus in accordance with another aspect of the present invention includes a system controller which performs a control including storing record error information in a memory when the record error occurred; reading out the record error information from the memory when the recording operation on the optical disc is finished; and recording the record error information in a predetermined area on the optical disc. Therefore, with respect to the optical disc on which a record error occurred during recording operation, it is able to record on it the record error information such as an error occurrence address, a recording power, an error code, an internal error code and an error occurrence time after the recording operation is finished.

Therefore, if the optical disc causes a problem when it is reproduced, and it cannot be read, the user can send this optical disc to a service center or the like of the manufacturer of the optical disc so that the manufacturer of the optical disc can analyze the record error information recorded on the optical disc for finding out a cause of the error clear. Thus, the manufacturer of the optical disc can deal with the user's complaint and can use the information for developing an improved disc in the future and for improving efficiency in developing discs.

### BRIEF DESCRIPTION OF THE DRAWINGS

FIG. 1 is a block diagram to show a structure of an optical disc recording and reproducing apparatus according to an embodiment of the present invention.

FIGS. 2A and 2B are area structural diagrams to show a main area on an optical disc such as a DVD−R, a DVD−RW, a DVD+R or a DVD+RW.

FIG. 3 is a flowchart for explaining a process in which record error information that was generated in the recording operation is recorded on the optical disc in the present embodiment.

### DETAILED DESCRIPTION OF THE PREFERRED EMBODIMENTS

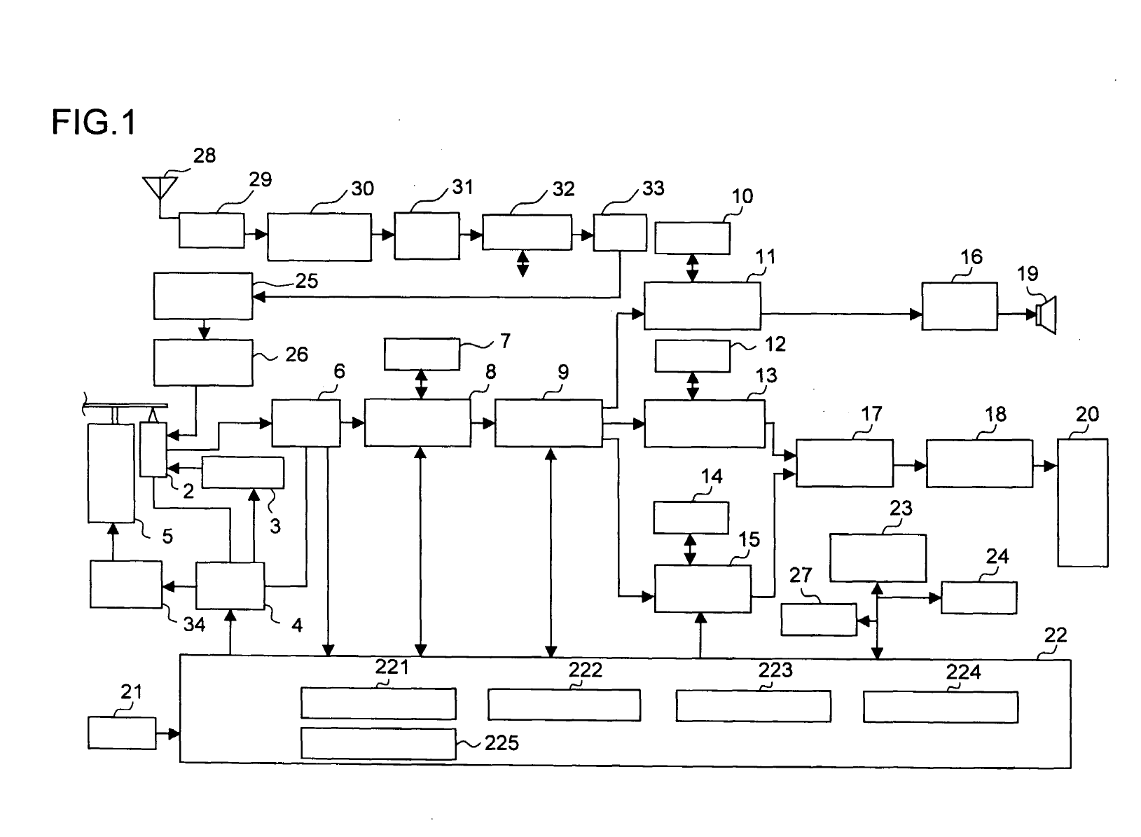

Hereinafter, as an example, one embodiment of the present invention will be described with reference to the attached drawings. FIG. 1 is a block diagram to show a structure of an optical disc recording and reproducing apparatus according to an embodiment of the present invention.

This optical disc recording and reproducing apparatus includes a system controller 22 that controls the entire apparatus, a spindle motor 5 that drives the optical disc 1 to rotate, an optical pickup 2 that writes and reads information optically on and from the optical disc 1, a thread 3 that makes the optical pickup 2 move in the radial direction of the optical disc 1 and a servo control portion 4 that drives the spindle motor 5 and the thread 3 via a motor driving circuit 34 in accordance with an instruction from the system controller 22 and moves the objective lens (not shown) embedded in the optical pickup 2 so as to move a focal position of a laser beam with respect to a recording surface of the optical disc 1 in the vertical and horizontal directions.

In addition, this optical disc recording and reproducing apparatus includes an RF amplifier 6 that amplifies an RF signal that is a read signal from the optical pickup 2 when the optical disc 1 is read, a digital signal processing portion 8 that converts the RF signal from the RF amplifier 6 into digital data and then performs a signal demodulation process and an error correction process in accordance with a data format of the optical disc 1 so that the generated data is stored in a RAM 7 as a buffer memory, and a stream separating portion 9 that separates audio data, sub picture data and video data from a data stream delivered from the digital signal processing portion 8 in accordance with an instruction from the system controller 22.

In addition, this optical disc recording and reproducing apparatus includes an audio decoder 11 that receives the audio data from the stream separating portion 9 and performs a predetermined decoding process on it, a RAM 10 that temporarily stores data for the audio decoder 11 to perform the decoding process, a sub picture decoder 13 that receives the sub picture data from the stream separating portion 9 and performs a predetermined decoding process on it, a RAM 12 that temporarily stores data for the sub picture decoder 13 to perform the decoding process, a video MPEG decoder 15 that receives the video data from the stream separating portion 9 and performs the MPEG decoding process on it, and a RAM 14 that temporarily stores data for the video MPEG decoder 15 to perform the decoding process.

In addition, this optical disc recording and reproducing apparatus includes a video processor 17 that combines the data from the video MPEG decoder 15 with the data from the sub picture decoder 13 in accordance with an instruction from the system controller 22, a video encoder 18 that converts the combined data from the video processor 17 into a video signal for display so that an image is displayed on a display device 20, and a D/A converter 16 that converts the data from the audio decoder 11 into an analog audio signal and supplies it to a speaker 19, for example, via an audio circuit (not shown).

This optical disc recording and reproducing apparatus is equipped with a remote controller 21 having various operational keys including a record key for issuing a record instruction to the system controller 22, a play key for issuing a play instruction to the same, a stop key for issuing a stop instruction of recording or reproducing to the same, and a main body operational portion (not shown) having operational keys fewer than the operational keys of the remote controller 21. This optical disc recording and reproducing apparatus includes a flash ROM 23 as a nonvolatile memory that stores programs and data for controlling each element of the apparatus and for controlling the entire apparatus, a CPU 24 that performs a computing processes in accordance with the programs and the data stored in the flash ROM 23 and controls the system controller 22, and a RAM 27 that temporarily stores data necessary for the CPU 24 to perform the computing processes.

In addition, this optical disc recording and reproducing apparatus includes a tuner 29 that is connected to an antenna 28, an A/D converter circuit 30 that converts analog picture and audio signal of a television broadcasting selected by the tuner 29 or a picture and audio signal from a television receiver or other picture and audio output device (not shown) into digital picture and audio data, an MPEG encoder 31 that encodes the picture and audio data by the MPEG format, a RAM 32 as a buffer memory that temporarily stores a predetermined quantity of the encoded picture and audio data (hereinafter referred to as encoded data), an AT Attachment Packet Interface (ATAPI) 33 that is an interface for making connection with a record data modulation circuit 25, a record data modulation circuit 25 that modulates the encoded data from the ATAPI 33 for recording it on the optical disc 1, and a laser modulation circuit 26 that supplies the optical pickup 2 with a laser modulation signal for modulating the laser beam emitted from the optical pickup 2 in accordance with modulation data that is modulated by the record data modulation circuit 25.

The system controller 22 includes structural elements that characterizes the present embodiment, which has a disc discriminating unit 221 that performs a disc discrimination of the loaded optical disc 1 based on the disc information, an error occurrence deciding unit 222 that decides whether or not a record error occurred while a recording operation was being performed on the optical disc 1 on which the disc discrimination had been performed, based on an error correction result, an error information storing unit 223 that stores record error information in the RAM 27 when it is decided that the record error occurred, an error occurrence confirming unit 224 that confirms whether or not a record error occurred while the recording operation was being performed on the optical disc 1 by detecting whether or not the record error information is stored in the RAM 27 when the recording operation on the optical disc 1 is finished, and an error information recording unit 225 that reads out the record error information from the RAM 27 when it is confirmed that the record error occurred, and records the read-out record error information in a recording management area of a DVD−R or a DVD−RW if the optical disc 1 that was disc-discriminated by the disc discriminating unit 221 is a DVD−R or a DVD−RW, while records the read-out record error information in an initial zone of a DVD+R or a DVD+RW if the optical disc 1 that was disc-discriminated by the disc discriminating unit 221 was a DVD+R or a DVD+RW.

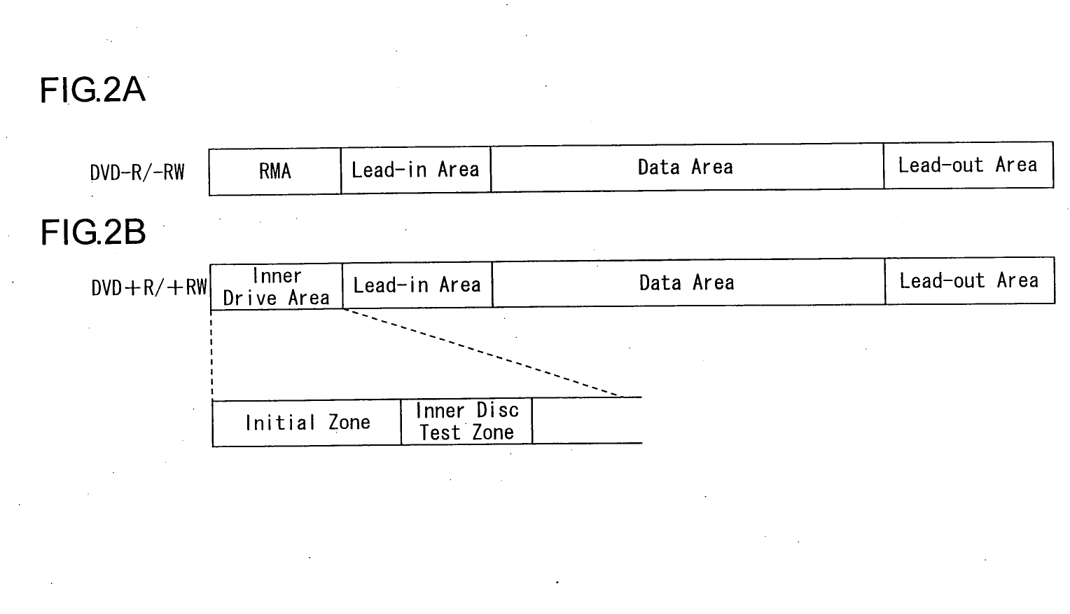

FIGS. 2A and 2B are area structural diagrams to show a main area on an optical disc such as a DVD−R, a DVD−RW, a DVD+R or a DVD+RW. As shown in FIG. 2A, an optical disc such as a DVD−R or a DVD−RW has a recording management area (RMA), a lead-in area, a data area and a lead-out area.

In addition, as shown in FIG. 2B, an optical disc such as a DVD+R or a DVD+RW has an inner drive area that is used for a drive test, a lead-in area, a data area and a lead-out area. The inner drive area includes an initial zone, an inner disc test zone and the like.

In the present embodiment, the record error information that includes the error occurrence address, the recording power, the error code, the internal error code and the error occurrence time is recorded in the recording management area (RMA) on the optical disc if it is a DVD−R or a DVD−RW as shown in FIG. 2A, while it is recorded in the initial zone on the optical disc if it is a DVD+R or a DVD+RW as shown in FIG. 2B.

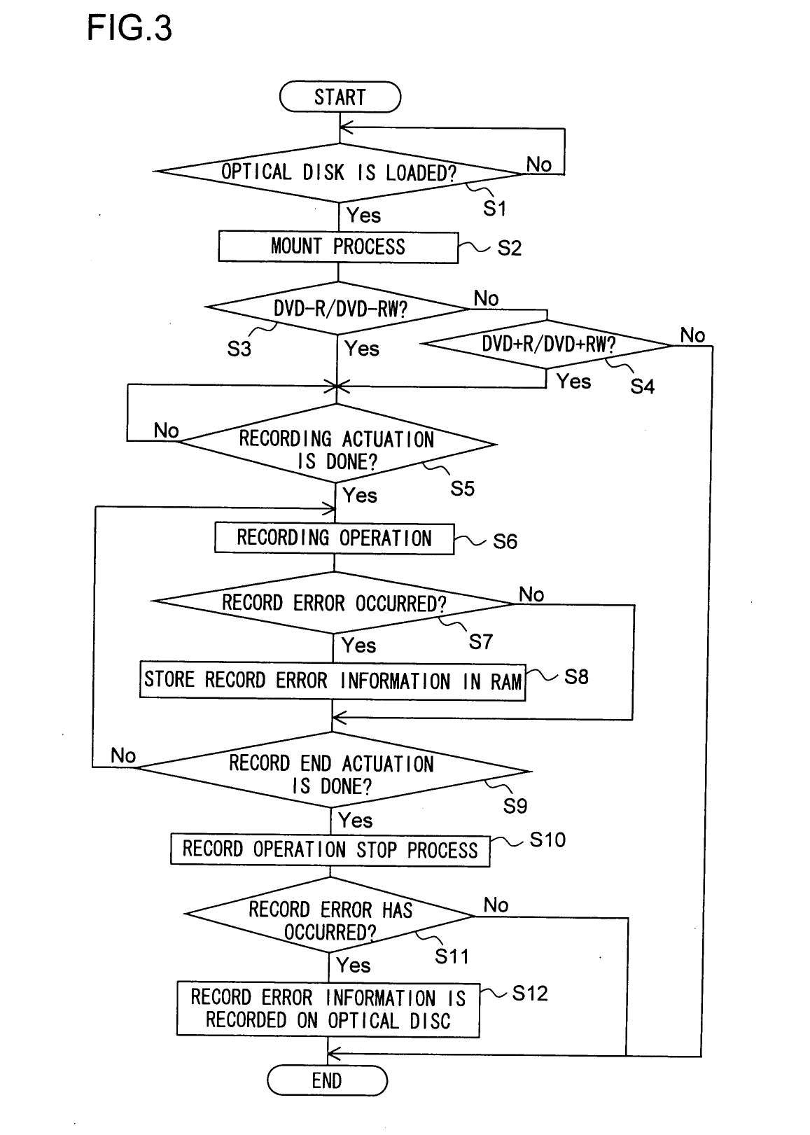

FIG. 3 is a flowchart for explaining a process in which record error information that was generated in the recording operation is recorded on the optical disc in the present embodiment. With reference to this flowchart and FIGS. 1 and 2, the process in which record error information that was generated in the recording operation is recorded on the optical disc will be described.

First, when the optical disc 1 is loaded, the system controller 22 detects the loading of optical disc 1 (Step S1), rotates the optical disc 1 slightly, and activates the optical pickup 2. It also performs a process of reading out the disc information (so-called a mount process) from a management area of the optical disc 1 (the recording management area (RMA) if the optical disc 1 is a DVD−R or a DVD−RW, or the initial zone if the optical disc 1 is a DVD+R or a DVD+RW) (Step S2). Then, based on the disc information, the disc discriminating unit 221 performs the decision whether the optical disc 1 is a DVD−R/DVD−RW (Step S3) or a DVD+R/DVD+RW (Step S4).

When the record key of the remote controller 21 is pressed (or when record start time of recording reservation comes), the system controller 22 detects that the recording actuation is done (Step S5) and makes the spindle motor 1 rotate the optical disc 1 via the servo control portion 4 and the motor driving circuit 34. It also moves the optical pickup 2 to a target position in the radial direction of the optical disc 1 via the servo control portion 4 and the thread 3, and it activates an actuator (not shown) via the servo control portion 4 so as to move the objective lens in the optical pickup 2 so that the laser beam is focused at a target position on the optical disc 1.

If the information to be written on the optical disc 1 is a television program that is received by the antenna 28 and selected by the tuner 29, a picture and audio signal from the tuner 29 is processed by the A/D converter circuit 30, the MPEG encoder 31, the RAM 32, the ATAPI 33, the record data modulation circuit 25 and the laser modulation circuit 26 that work as described above. Thus, the system controller 22 performs recording operation on the optical disc 1 via the optical pickup 2 (Step S6).

When the recording operation is performed as described above, the error occurrence deciding unit 222 of the system controller 22 decides whether or not a record error occurred in the recording operation (Step S7). More specifically, information is read out from a recorded area of the optical disc 1 by the optical pickup 2, and the signal is amplified by the RF amplifier 6 and is supplied to the digital signal processing portion 8. The digital signal processing portion 8 converts the RF signal into digital data and then performs the signal demodulation process and the error correction process in accordance with the data format of the optical disc 1. The error occurrence deciding unit 222 of the system controller 22 detects the error correction result of the ECC block in the digital signal processing portion 8 so as to decide whether or not a record error occurred in the recording operation. At this point, the process of reading out information from the recorded area of the optical disc 1 for deciding whether or not a record error occurred in the recording operation can be performed by the system controller 22 that switches the optical pickup 2 between the writing operation and the reading operation at a predetermined time period.

When the recording operation is performed in this way (Step S6), if the error occurrence deciding unit 222 decides that a record error occurred (Step S7), the error information storing unit 223 of the system controller 22 stores the record error information that includes the error occurrence address on the optical disc 1 when the record error occurred, the recording power of the laser beam emitted from the optical pickup 2 just before the record error occurred, the error code that indicates contents of the record error, the internal error code that indicates contents of the error more specifically than the error code and the error occurrence time when the record error occurred (time corresponding to recording elapsed time in the recording process) in the RAM 27 (Step S8).

When the stop key of the remote controller 21 is pressed (or when record end time of recording reservation comes), the system controller 22 detects that a record end actuation is done (Step S9) and performs a record operation stop process in which rotation of the spindle motor 1 is stopped via the servo control portion 4 and the motor driving circuit 34 so that rotation of the optical disc 1 is stopped, and the operation of the optical pickup 2 is stopped via the servo control portion 4 (Step S10).

After the record operation stop process is performed in this way, the error occurrence confirming unit 224 of the system controller 22 makes an access to the RAM 27 and detects whether or not error information is stored in the RAM 27, so as to confirm whether or not an error occurred during the recording operation on the optical disc 1 (Step S11). If it is decided that the RAM 27 does not store error information and a record error didn't occur during the recording operation, the process is finished as it is. On the contrary, if it is decided that the RAM 27 stores error information and a record error occurred during the recording operation, the error information recording unit 225 of the system controller 22 records the record error information in a predetermined area on the optical disc 1 (Step S12).

More specifically, if the disc-discriminated optical disc 1 is a DVD−R or a DVD−RW in the steps S3 and S4, the error information recording unit 225 reads out the record error information from the RAM 27 and sends this record error information to the ATAPI 33. The record error information is processed in a predetermined manner by the record data modulation circuit 25 and the laser modulation circuit 26, and the optical pickup 2 is activated so that the record error information is recorded in the recording management area (RMA) on the DVD−R or the DVD−RW. If the disc-discriminated optical disc 1 is a DVD+R or a DVD+RW, the error information recording unit 225 read out the record error information from the RAM 27 in the same manner. This record error information is sent to the ATAPI 33 and is processed by the record data modulation circuit 25 and the laser modulation circuit 26 in a predetermined manner, and the optical pickup 2 is activated so that the record error information is recorded in the initial zone on the DVD+R or the DVD+RW.

In this way, if a record error occurred during the recording operation on an optical disc, the record error information such as the error occurrence address, the recording power, the error code, the internal error code, the error occurrence time and the like is recorded on the optical disc after the recording operation is finished. Therefore, if this optical disc causes a problem when it is reproduced, and it cannot be read, the user can send this optical disc to a service center or the like of the manufacturer of the optical disc so that the manufacturer of the optical disc can analyze the record error information recorded on the optical disc for finding out a cause of the error clear. Thus, the manufacturer of the optical disc can deal with the user's complaint and can use the information for developing an improved disc in the future and for improving efficiency in developing discs.

The present invention can be used for the manufacturer of the optical disc to analyze causes of problems and to use the result for developing improved discs, when a record error occurred on an optical disc such as a DVD−R, a DVD−RW, a DVD+R or a DVD+RW, and it cannot be read for a problem, by adding a function of recording record error information on the optical disc to a DVD recorder as an optical disc recording and reproducing apparatus.

What is claimed is:

1. An optical disc recording and reproducing apparatus comprising:
an error occurrence deciding unit that decides whether or not a record error occurred during recording operation on an optical disc;
an error information storing unit that stores record error information in a memory when the record error occurred; and
an error information recording unit that reads out the record error information from the memory and records the record error information in a predetermined area on the optical disc when the recording operation is finished if a record error occurred during the recording operation.

2. The optical disc recording and reproducing apparatus according to claim 1, wherein the predetermined area in which the record error information is recorded on the optical disc is a recording management area in the case where the optical disc is a DVD−R or a DVD−RW, while it is an initial zone in the case where the optical disc is a DVD+R or a DVD+RW.

3. The optical disc recording and reproducing apparatus according to claim 1, further comprising:
a disc discriminating unit that discriminates a type of the optical disc based on disc information; and
an error occurrence confirming unit that confirms whether or not a record error occurred during the recording operation by detecting whether or not the record error information is stored in the memory when the recording operation on the optical disc is finished, wherein the predetermined area is decided in accordance with a result of the discrimination performed by the disc discriminating unit.

4. The optical disc recording and reproducing apparatus according to claim 3, wherein the predetermined area is a recording management area in the case where the optical disc is a DVD−R or a DVD−RW, while it is an initial zone in the case where the optical disc is a DVD+R or a DVD+RW.

5. An optical disc recording and reproducing apparatus that has a system controller comprising:
a disc discriminating unit that discriminates a type of an optical disc based on disc information;
an error occurrence deciding unit that decides whether or not a record error occurred during recording operation on the discriminated optical disc based on an error correction result;
an error information storing unit that stores record error information in a memory when the record error occurred;
an error occurrence confirming unit that confirms whether or not a record error has occurred during the recording operation on the optical disc by detecting whether or not the record error information is stored in the memory when the recording operation on the optical disc is finished; and
an error information recording unit that reads out the record error information from the memory, if it is confirmed that the record error occurred, and records the record error information in a recording management area in the case where the optical disc is a DVD−R or a DVD−RW, while records the same in an initial zone in the case where the optical disc is a DVD+R or a DVD+RW.
